(19) United States
(12) Patent Application Publication
(10) Pub. No.: US 2022/0282862 A1
(43) Pub. Date: Sep. 8, 2022

(54) Elastically Positionable Lamp for Grooming Devices

(71) Applicant: Nicholas Fellows, Dallas, TX (US)

(72) Inventor: Nicholas Fellows, Dallas, TX (US)

(21) Appl. No.: 17/685,164

(22) Filed: Mar. 2, 2022

Related U.S. Application Data
(60) Provisional application No. 63/155,324, filed on Mar. 2, 2021.

(51) Int. Cl. F21V 33/00; B26B 19/46

(52) U.S. Cl. CPC F21V 33/0084; B26B 19/46; A01K 13/002

(57) ABSTRACT

A device that allows the user to radially position a lamp around the outside surface of a grooming device, such as an electric trimmer, such that the lamp illuminates the end of the device when used is disclosed. Ordinarily the lamp is a light emitting diode (LED) powered by a small battery.

### CROSS-REFERENCE TO RELATED APPLICATIONS

This application refers to U.S. Prov. App. No. 63/155324 filed Mar. 2, 2021, and incorporates that application, in its entity, by reference.

### FIELD OF THE INVENTION

The present invention relates to an elastic device that allows the user to radially position a lamp around the outside surface of a grooming device such as an electric trimmer such that the lamp illuminates the end of the device when used. Ordinarily the lamp is a light emitting diode (LED) powered by a small battery.

### BACKGROUND OF THE INVENTION

Currently, there are numerous grooming devices that have lights or lamps built into them to illuminate the end of the device when it is used. For practitioners with older equipment without a light or lamp built in, the user requires a strong, free-standing lamp to illuminate the area where the practitioner is working. Such illumination is necessary to achieve accurate cuts, trims, and other treatments.

Therefore, it is a first goal of the present invention to provide a flexible device that may be affixed around the shaft of a grooming device to attach a lamp or LED to the grooming device such that the end of the grooming device is illuminated when it is used.

It is a second goal of the present invention to provide a flexible device that may be positioned on the shaft of a grooming device at any radial position: top, left side, right side, or bottom.

It is a third goal of the present invention to provide the flexible device in a variety of sizes (radii) so that it may be attached to varying sizes of grooming equipment.

It is a fourth goal of the present invention to provide the flexible device with an attachment point that may be used to affix a lamp or an LED or a similar device, such as a digital camera or a thermal sensor.

### SUMMARY OF THE INVENTION

The exemplary embodiment of the present invention is comprised of an elastic ring with an outwardly protruding flexible pocket for affixing a small lamp or LED to the elastic ring. When equipped with a lamp or LED, the elastic ring is slid over the body of a grooming device so that the lamp or LED faces the operating head of the grooming device when it is in use. Similarly, the lamp or LED may be affixed to the elastic ring such that it faces the end away from the operating end. By this means, the lamp or LED may illuminate the operator or the operator's hand. Similarly, equivalent-sized portable devices may be affixed to the elastic ring in the flexible pocket. Specifically, a digital camera device or a thermal sensor may be affixed to the elastic ring. These equivalent devices may be positioned such that they face either end of the grooming device.

The elastic ring may be radially positioned at any point on the body of the grooming device, such that the lamp or LED, when illuminated, illuminates the end of the grooming device where it contacts the skin of the individual on whom it is being used. Similarly, equivalent-sized portable devices may be affixed and radially positioned at any point on the body of the grooming device.

The exemplary embodiment of the present invention is molded or otherwise constructed of silicone rubber, silastic rubber, rubber, or any other suitable flexible material. The outwardly protruding flexible pocket is also molded or otherwise constructed of silicone rubber, silastic rubber, rubber, or any other suitable flexible material. In one embodiment of the present invention, the outwardly protruding flexible pocket contains an open space where a button-sized device or device-mounting appendage may be affixed.

To use the invention, a compact lamp or LED is positioned in the flexible pocket such that the light emitting surface of the lamp or LED faces in the direction desired. Usually, the light emitting surface of the lamp or LED faces directly towards the operating end of the grooming device. Next, the user illuminates the lamp or LED. Next, the user then performs a hair trimming or styling service on the body of the customer.

### BRIEF DESCRIPTION OF THE DRAWINGS

FIG. 1 is a rear elevation of one embodiment of an elastic ring.

FIG. 2 is a front elevation of one embodiment of an elastic ring.

FIG. 3 is a side elevation of one embodiment of an elastic ring.

FIG. 4 is a top plan view of one embodiment of an elastic ring showing how a compact lamp or LED is affixed to the elastic ring.

### DETAILED DESCRIPTION OF THE PREFERRED EMBODIMENT

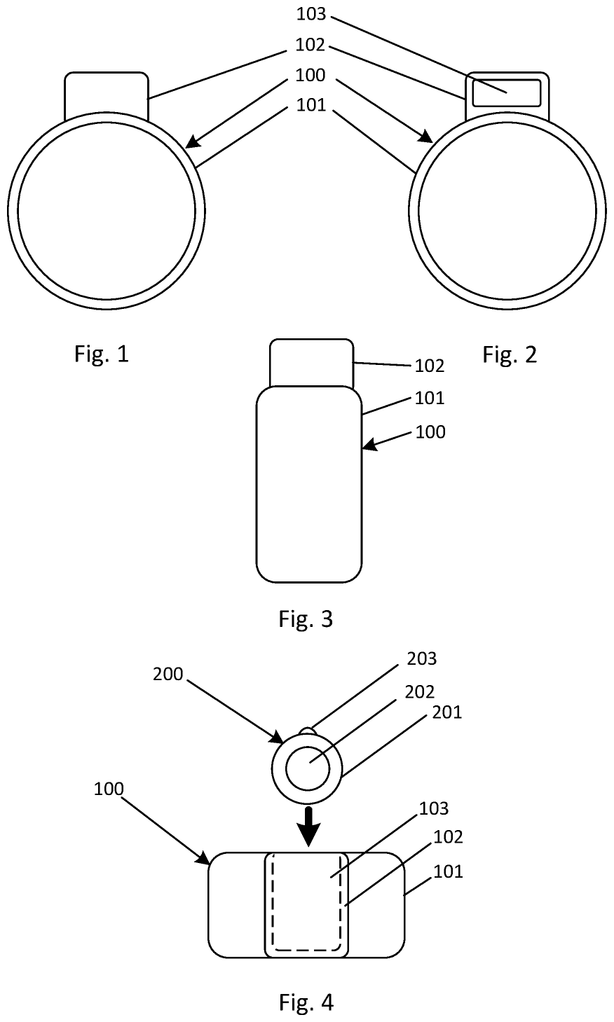

Referring now to FIGS. 1 through 3, the exemplary embodiment of the present invention 100 is comprised of an elastic ring 101 with an outwardly protruding flexible pocket 102 for affixing a small lamp or LED to the elastic ring 101. When equipped with a lamp or LED, the elastic ring 101 is slid over the body of a grooming device so that the lamp or LED faces the operating head of the grooming device when it is in use. Similarly, the lamp or LED may be affixed to the elastic ring 101 such that it faces the end away from the operating end. By this means, the lamp or LED may illuminate the operator or the operator's hand. Similarly, equivalent-sized portable devices may be affixed to the elastic ring 101 in the opening in the flexible pocket 103. Specifically, a digital camera device or a thermal sensor may be affixed to the elastic ring 101. These equivalent devices may be positioned such that they face either end of the grooming device.

The elastic ring 101 may be radially positioned at any point on the body of the grooming device, such that the lamp or LED, when illuminated, illuminates the end of the grooming device where it contacts the skin of the individual on whom it is being used. Similarly, equivalent-sized portable devices may be affixed and radially positioned at any point on the body of the grooming device.

The exemplary embodiment of the present invention 100 is molded or otherwise constructed of silicone rubber, silastic rubber, rubber, or any other suitable flexible material.

The outwardly protruding flexible pocket 102 is also molded or otherwise constructed of silicone rubber, silastic rubber, rubber, or any other suitable flexible material. In one embodiment of the present invention 100, the outwardly protruding flexible pocket 102 contains an opening in the flexible pocket 103 where a button-sized device or device-mounting appendage may be affixed is provided.

Turning now to FIG. 4, to use the invention a compact lamp or LED device 200 is slid into outwardly protruding flexible pocket 102 by means of the opening in the flexible pocket 103 such that the light emitting surface of the lamp or LED 203 faces in the direction desired. Usually, the light emitting surface of the lamp or LED 203 faces directly towards the operating end of the grooming device. Next, the user illuminates the lamp or LED 203 by actuating button 202 or some other kind of manually accessible switching device. Next, the user performs a hair trimming or styling service on the body of the customer.

While the present invention has been described in what are thought to be the most useful and practical embodiments, it will be readily apparent to those having skill in the art that other variations may be readily conceived and created. Accordingly, these and all such other readily conceived and created variations are implicitly included in the spirit and scope of the present disclosure.

What is claimed is:

1. A flexible ring with a flexible pocket affixed on the outer surface
a) wherein the flexible pocket has an opening such that a lamp or LED may be at least partially inserted;
b) wherein the flexible ring may be slid over and stretchably affixed to the body of a grooming instrument and radially adjusted such that the outwardly pointing longitudinal axis of the lamp or LED may be aligned along any long axis of the grooming instrument;
c) wherein the lamp or LED may be activated and illuminate the working end of the grooming instrument while it is being used to groom an individual or animal.

2. A flexible ring with a flexible pocket affixed on the outer surface of claim 1 wherein the flexible ring and flexible pocket are made of rubber.

3. A flexible ring with a flexible pocket affixed on the outer surface of claim 1 wherein the flexible ring and flexible pocket are made of silastic rubber.

4. A flexible ring with a flexible pocket affixed on the outer surface of claim 1 wherein in the flexible ring and flexible pocket are made of silicone rubber.
